(19) United States
(12) Patent Application Publication
(10) Pub. No.: US 2022/0270191 A1
(43) Pub. Date: Aug. 25, 2022

(54) SYSTEM FOR AUTOMATICALLY SPLITTING SMART CONTRACT

(71) Applicant: PILAB CO., LTD, Seoul (KR)

(72) Inventors: Jong Hyup LEE, Seoul (KR); Do Hyun PAK, Seoul (KR)

(73) Assignee: PILAB CO., LTD, Seoul (KR)

(21) Appl. No.: 17/640,150

(22) PCT Filed: Nov. 4, 2019
(86) PCT No.: PCT/KR2019/014803

§ 371 Date: Mar. 3, 2022

(30) Foreign Application Priority Data
Sep. 6, 2019 (KR) 10-2019-0110461

(51) Int. Cl. G06Q 50/18

(52) U.S. Cl. CPC G06Q 50/184

(57) ABSTRACT

Provided is a system for automatically splitting a smart contract. More particularly, provided is a system for automatically splitting a smart contract, wherein assuming that a blockchain service permits the use of a plurality of blockchains to overcome limitations of security or performance provided by one blockchain, the system splits codes of one smart contract and enables the same to operate in the respective blockchains.

### TECHNICAL FIELD

The present disclosure relates to a system for automatically splitting a smart contract. More particularly, the present disclosure relates to a system for automatically splitting a smart contract, wherein assuming that a blockchain service permits the use of a plurality of blockchains to overcome limitations of security or performance provided by one blockchain, the system splits codes of one smart contract and enables the same to operate in conjunction with each other in the respective blockchains.

### BACKGROUND ART

A smart contract is a technology for making and modifying a contract easily and conveniently in a P2P manner without intermediators. The smart contract may be defined as a computer program or computer program code that automatically executes the details of a written contract when a predefined condition is satisfied in blockchain fields (for example, Bitcoin, such as Ethereum, Ripple, and Quantum, financial services, copyright management and document notarization, an initial coin offering (ICO), online shopping site operation, IoT utilization, etc.). In addition, the smart contract is a programmable contract that can be used in various fields as described below in addition to the contract such as the above-described asset transaction. The main feature is that many nodes used in a distributed system environment conduct the same transaction, so that the state of the program is the same and the user thus has trust.

In addition, the smart contract is capable of managing the tasks that need to be automatically operated on a blockchain as well as performing management about a cryptocurrency, so the smart contract is used for various purposes, such as an initial coin offering (ICO), Ethereum token issuance, and online shopping site operation.

Such a smart contract may be used in one blockchain or a plurality of blockchains. The conventional smart contract is generally used in one blockchain, but there is a problem with the security of the single blockchain or there is a blockchain system having limitations of performance in managing a smart contract.

Therefore, to overcome the problem with security of the blockchain system or the limitations of the performance, there is a growing need for a smart contract used in a plurality of blockchains. In order to use a smart contract in a plurality of blockchains, a technology for splitting a smart contract appropriately with ensured reliability is required.

### DISCLOSURE

### Technical Problem

Accordingly, the present disclosure has been made keeping in mind the above problems, and the present disclosure is directed to automatically splitting an automated smart contract on the basis of a given condition and providing the same.

### Technical Solution

According to the present disclosure, there is provided a system for automatically splitting a smart contract of a user on the basis of a preset condition, the system including: a separation area designator configured to split the smart contract so that the smart contract operates for one or more blockchain domains; a code generator configured to generate a separate code corresponding to each of the blockchain domains, on the basis of a smart contract code after an area to be split off is designated; and an operator configured to enable parts resulting from splitting the smart contract to operate in conjunction with each other in the blockchain domains respectively.

Regarding the separation area designator, the user may perform manual designation or automatic designation may be performed using inference. The code generator may be configured to determine whether a variable used and a function to be called belong to the same area, by analyzing the existing smart contract code, then transform the smart contract code on the basis of marked information, and generate the separate code for each of the blockchain domains.

In addition, the operator may further require a linker in order for the parts resulting from splitting the smart contract to operate in conjunction with each other in the blockchain domains respectively.

### Advantageous Effects

Assuming that a blockchain service permits the use of a plurality of blockchains to overcome limitations of security or performance provided by one blockchain, the system for automatically splitting a smart contract according to the present disclosure can split codes of one smart contract and enable the same to operate in the respective blockchains.

### DESCRIPTION OF DRAWINGS

FIGS. 1A and 1B is a conceptual diagram illustrating separation area designation of a system for automatically splitting a smart contract according to an embodiment of the present disclosure.

FIG. 2 is a conceptual diagram illustrating code analysis and code generation according to an embodiment of the present disclosure.

### MODE FOR INVENTION

A blockchain domain described throughout the specification means one blockchain system that performs independent operation. Herein, the independent operation means splitting at a transaction level. Even when blockchain systems are of the same type, it is assumed that blockchains are independent when the blockchain systems do not share their ledgers in which blockchain information is recorded. For example, even when a plurality of blockchains are supported through a merged mining method, if the ledgers between two blockchains are different, the blockchains are defined as independent blockchain domains.

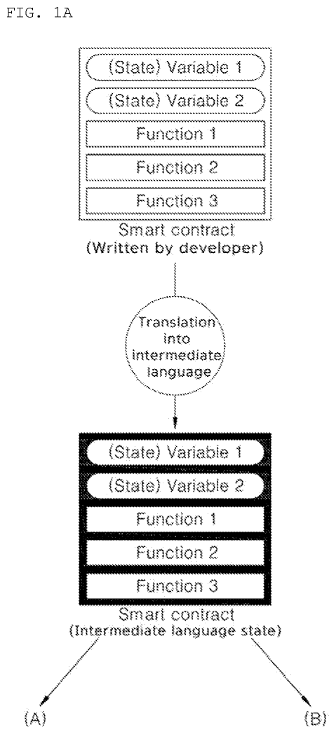

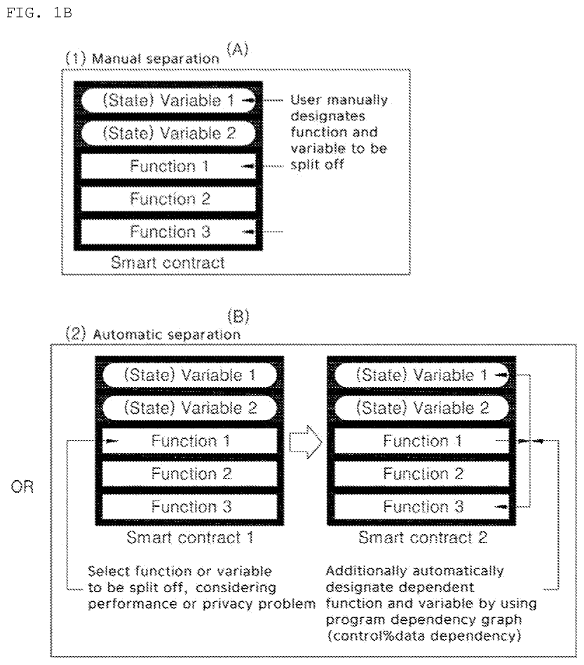

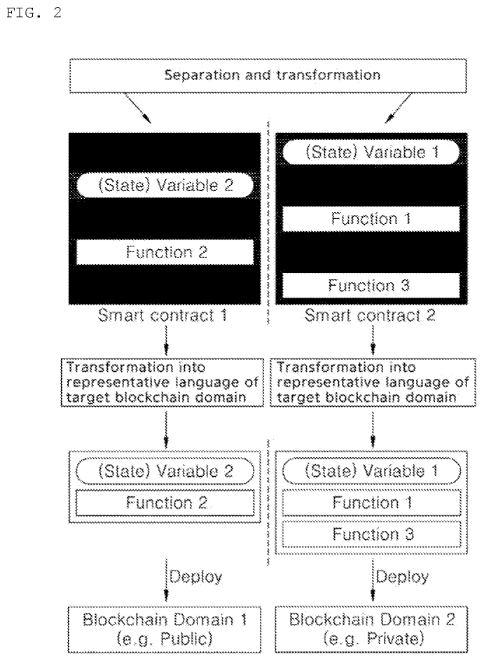

FIGS. 1A and 1B is a conceptual diagram illustrating separation area designation of a system for automatically splitting a smart contract according to an embodiment of the present disclosure. FIG. 2 is a conceptual diagram illustrating code analysis and code generation according to an embodiment of the present disclosure. Hereinafter, an exemplary embodiment of the present disclosure will be described in detail with reference to the accompanying drawings. As shown in FIGS. 1A, 1B and 2, a system for splitting a smart contract of a user on the basis of a preset condition schematically includes a separation area designator, a code generator, and an operator.

The separation area designator splits one smart contract so that the smart contract operates for at least one blockchain domain. The system for automatically splitting a smart contract according to the embodiment of the present disclosure splits one smart contract so that the smart contract operates for one or more blockchain domains.

That is, there is a need for a method of designating an area that will operate in each blockchain domain, on the basis of a given smart contract. It is assumed that definition of an area is based on a function of code. Herein, the system for automatically splitting a smart contract according to the embodiment of the present disclosure uses two methods in designating a separation area.

First, a manually designating method is used. A developer may define an area by marking a part corresponding to each blockchain domain in person on smart contract code. Second, an automatically designating method using inference may be used. When a developer marks a part suitable for a particular blockchain domain within smart contract code, control dependency and data dependency are calculated through a program analysis process, centering around the marked part. Connected functions and variables are automatically designated as the code to be included in the area.

Afterward, when the area to be split off is designated, a separate code corresponding to each blockchain domain is generated on the basis of the smart contract code. Such a separation and generation process is a smart contract separation and generation process, and is performed through the following three steps.

First, Step 1 is to analyze code for splitting. By analyzing the existing smart contract code with a static analysis or dynamic analysis method, it is determined whether a variable used and a function to be called belong to the same area. The determined result is marked at the corresponding location in the program and is used in a subsequent step.

Step 2 is to transform the code for interworking. On the basis of the information marked at the previous step, the smart contract code is transformed.

First, in the case of a function, when the function to be called corresponds to a different blockchain domain, function call syntax is changed so that an operation system recognizes that the call has occurred. For example, in the case of an Ethereum system, change to event generation (emission) syntax takes place. Conversely, when the function to be called is included in the same blockchain domain, a general function call statement is changed and used.

Next, in the case of a variable, when different blockchain domains use the same variable, the blockchain domain in which the variable is most used is selected and the variable is located therein. In addition, a setter function for setting the value of the variable and a getter function for reading the value of the variable are automatically generated, and the code is changed so that a different blockchain domain using the variable accesses the variable through the generated setter function and the generated getter function.

Step 3 is to generate a code for each blockchain domain. On the basis of the smart contract code resulting from transformation for interworking at the previous step, a code is generated corresponding to each blockchain domain. In the code generation process, the structures of code and instructions are changed corresponding to each blockchain domain. Herein, the generated code is generated in the programming language that is typically used in each blockchain domain and goes through an installation (deploy) process. Therefore, when the programming language of the written smart contract code is different from that of the generated code, programming language translation is performed. In addition, when address translation is internally required in the process of executing the smart contract, the code is changed so that the address resulting from translation is used through registered information of the linker. Specification information for connecting and operating the code generated in the above-described process in different blockchain domains is also automatically generated. Afterward, when a call for a smart contract located in a different blockchain domain occurs, the linker system performs connection on the basis of the provided specification information. When address translation of the used address is required, the linker system is in charge of setting an address translation contract for supporting address translation.

Afterward, the parts resulting from splitting the smart contract pass through the operator so as to operate in conjunction with each other in the respective blockchain domains. Herein, the operator needs support from a system, which will be described later, in an operation process. The system for operation support is defined as a linker. The operator receives the support for access relay and address translation from the system.

Regarding the access relay, when it is desired to call a function or use a variable located in a different blockchain domain, direct access is limited, so a connecting task through an external system is required. The linker is the technique proposed for this task. The linker observes the processes of executing developed smart contracts, and when a call between blockchain domains is requested, the linker transfers the request to the corresponding blockchain so that interworking takes place.

Regarding the address translation, a general blockchain system has an address system based on a public-key system to identify each entity. However, when smart contracts are located in different blockchain domains, addresses of the installed smart contracts as well as addresses of other interacting entities may vary from blockchain domain to blockchain domain. Therefore, through the linker, translation information of the address required in the execution process is registered in each blockchain domain, and a code using the address resulting from change is automatically generated while the smart contract is in use.

In addition, the system for automatically splitting a smart contract according to the embodiment of the present disclosure is a configuration that includes all devices that accept a smart contract from a blockchain system. That is, a smartphone, a pad, and a laptop computer capable of accessing the Internet are possible. Broadly, all computing devices in a desktop environment may be included.

In addition, individual or selectively combined elements constituting the system for automatically splitting a smart contract according to the embodiment of the present disclosure may be realized as a computer program stored in a storage medium for execution through combination with a computer.

In addition, individual or selectively combined elements constituting the system for automatically splitting a smart contract according to the embodiment of the present disclosure may be realized in the form of program instructions executable by various computer means and may be recorded on a computer-readable recording medium. For example, the system for splitting including the separation area designator, the code generator, and the operator may be stored in a computer-readable recording medium and may perform its functions.

The computer-readable recording medium may include program commands, data files, data structures, and the like separately or in combinations. The program commands to be recorded on the computer-readable recording medium may be specially designed and configured for the embodiment of the present disclosure or may be well-known to and be usable by those skilled in the art of computer software. Examples of the computer-readable recording medium include magnetic recording media such as hard disks, floppy disks and magnetic tapes; optical data storage media such as CD-ROMs or DVD-ROMs; magneto-optical media such as floptical disks; and hardware devices, such as read-only memory (ROM), random-access memory (RAM), flash memory, and solid-state drives (SSDs), which are particularly structured to store and implement the program instructions. Examples of the program instructions include not only a mechanical language code formatted by a compiler but also a high level language code that may be implemented by a computer using an interpreter, and the like.

In addition, as the form of a mobile communication terminal is changed into a smartphone and the computing power has increased remarkably, the configuration such as the computer or the computer program used in the present disclosure may be used in the same meaning as a smartphone or an application executed on a smartphone.

Although the present disclosure has been described with reference to the exemplary embodiment, those skilled in the art will appreciate that various modifications and variations can be made in the present disclosure without departing from the spirit or scope of the disclosure described in the appended claims.

1. A system for automatically splitting a smart contract of a user on the basis of a preset condition, the system comprising:
a separation area designator configured to split the smart contract so that the smart contract operates for one or more blockchain domains;
a code generator configured to generate a separate code corresponding to each of the blockchain domains, on the basis of a smart contract code after an area to be split off is designated; and
an operator configured to enable parts resulting from splitting the smart contract to operate in conjunction with each other in the blockchain domains respectively,
wherein in the separation area designator, the user performs manual designation or automatic designation is performed using inference, and in a case where the automatic designation is performed using interference when a developer marks a part suitable for a particular blockchain domain within the smart contract code, control dependency and data dependency are calculated through a program analysis process, centering around a marked part, and connected functions and variables are automatically designated as the code to be included in the area,
wherein the code generator is configured to determine whether a variable used and a function to be called belong to the same area, by analyzing the existing smart contract code, then transform the smart contract code on the basis of marked information, and generate the separate code for each of the blockchain domains, and
wherein when different blockchain domains use the same variable, the blockchain domain in which the variable is most used is selected and the variable is located therein, and a setter function for setting the value of the variable and a getter function for reading the value of the variable are automatically generated, and the code is changed so that a different blockchain domain using the variable accesses the variable through the generated setter function and the generated getter function.

2. (canceled)

3. (canceled)

4. The system of claim 1, wherein the operator further requires a linker in order for the parts resulting from splitting the smart contract to operate in conjunction with each other in the blockchain domains respectively.
